(19) United States
(12) Patent Application Publication
(10) Pub. No.: US 2014/0068998 A1
(43) Pub. Date: Mar. 13, 2014

(54) FISHING ACCESSORY CONTAINER

(71) Applicant: Michael Anthony Peak, Dothan, AL (US)

(72) Inventor: Michael Anthony Peak, Dothan, AL (US)

(21) Appl. No.: 14/018,233

(22) Filed: Sep. 4, 2013

Related U.S. Application Data
(60) Provisional application No. 61/743,656, filed on Sep. 10, 2012.

(51) Int. Cl. A01K 97/06; A01K 97/04

(52) U.S. Cl. CPC A01K 97/06; A01K 97/04
USPC 43/55

(57) ABSTRACT

A container having a cooler and a tackle box is provided. The cooler of the present invention may have a plurality of sidewalls and a hinged lid with a cavity in between. The tackle box may include a compartment with a plurality of slots containing a plurality of drawers to store tackle. The present invention may further include a fishing pole rack, a plurality of hooks and additional compartments. The present invention may further include a handle and wheels.

### CROSS-REFERENCE TO RELATED APPLICATION

This application claims the benefit of priority of U.S. provisional application No. 61/743,656, filed Sep. 10, 2012, the contents of which are herein incorporated by reference.

### BACKGROUND OF THE INVENTION

The present invention relates to a multi-purpose container and, more particularly, to a multi-purpose container with a tackle box and cooler.

Fishing is the activity of trying to catch fish. Fish are normally caught in the wild. Techniques for catching fish include hand gathering, spearing, netting, angling, and trapping. Typically, especially for recreational purposes, angling is a very common type of fishing. Angling may include fishing using a hook that is usually attached to a fishing line and the line is often attached to a fishing rod. When angling, a user may need an assortment of equipment, including a tackle box, bait, a cooler, a chair, a bucket, a net, and the like. Carrying all of the equipment to a fishing spot may be cumbersome and taking multiple trips back and forth from a car takes time away from fishing.

As can be seen, there is a need for an all encompassing container for recreational fishing.

### SUMMARY OF THE INVENTION

In one aspect of the present invention, a multi-purpose container comprises: a cooler comprising sidewalls forming a cavity within, wherein the cooler comprises a hinged lid that is opened and closed to access the cavity; and a tackle box attached to the cooler, wherein the tackle box comprises at least one compartment.

These and other features, aspects and advantages of the present invention will become better understood with reference to the following drawings, description and claims.

### BRIEF DESCRIPTION OF THE DRAWINGS

FIG. 1 is a front perspective view of the present invention demonstrated in a compact form;

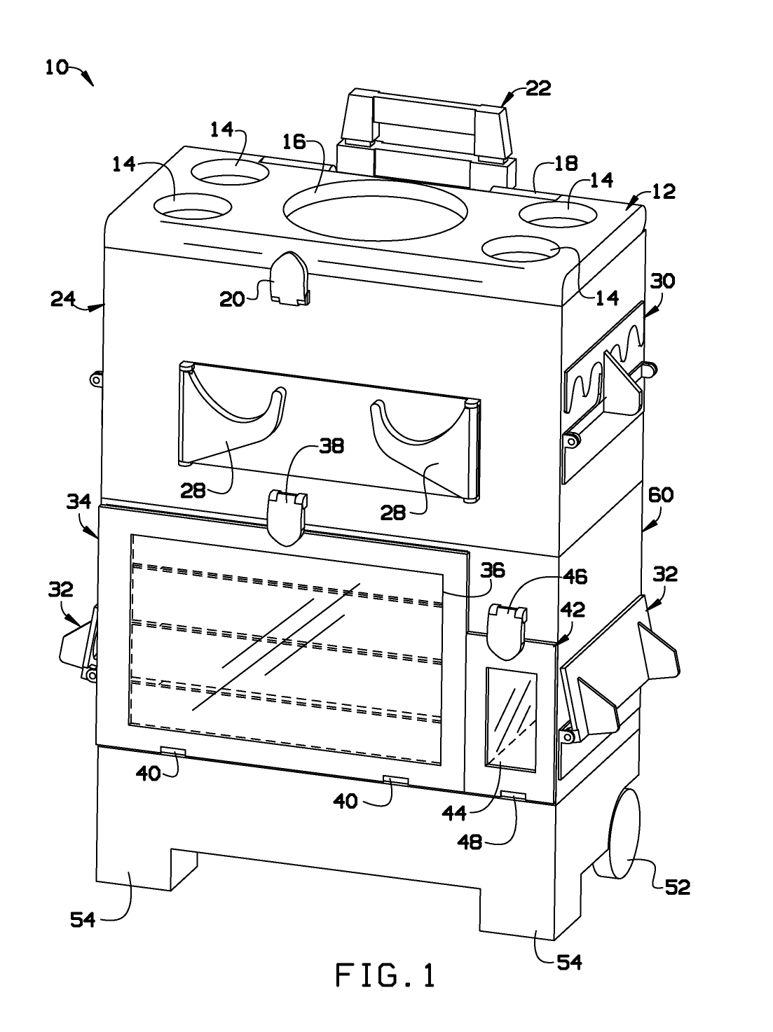

FIG. 2 is a front perspective view of the present invention demonstrated in compact form;

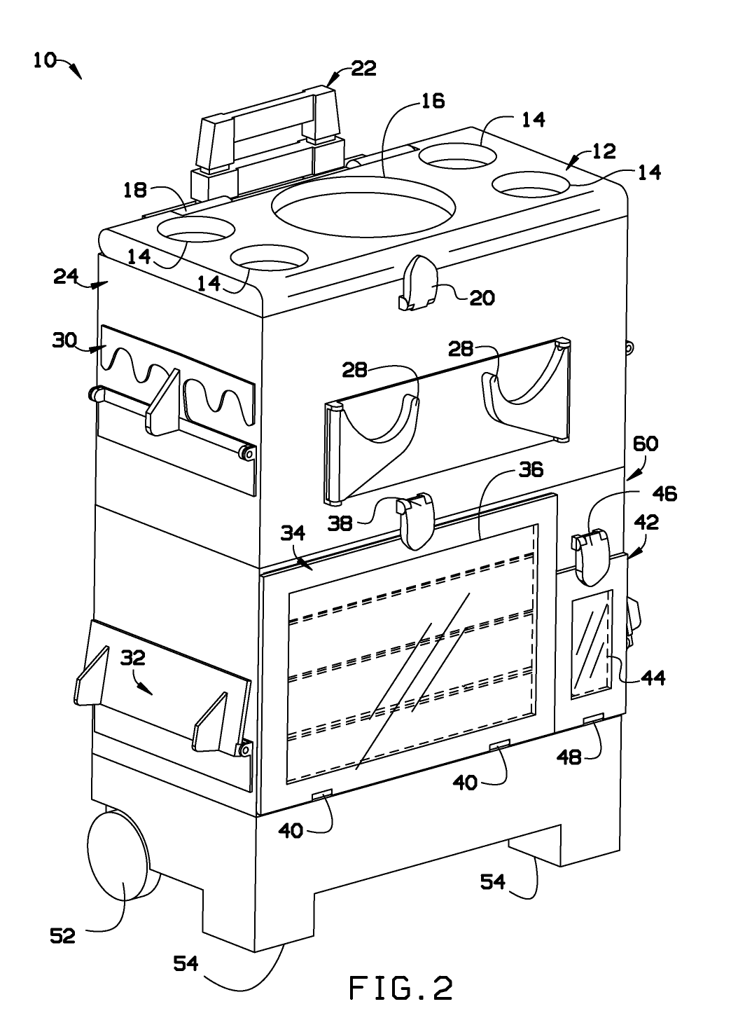

FIG. 3 is a front perspective view of the present invention demonstrated in an expanded form; and

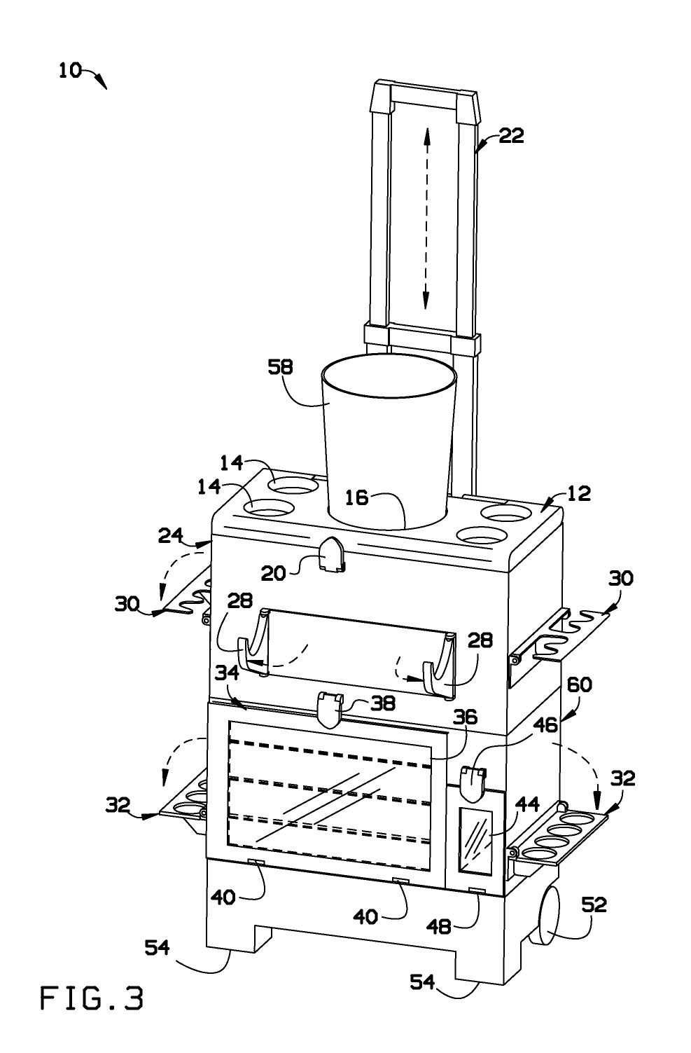

FIG. 4 is a front perspective view of the present invention demonstrated in an open position.

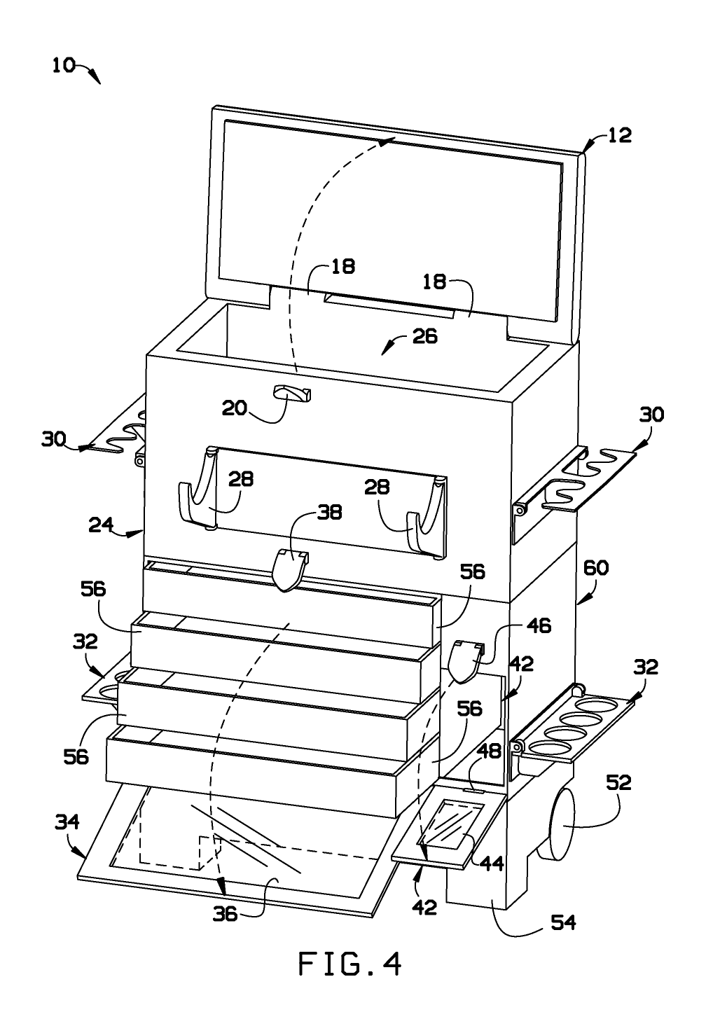

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a container having a cooler and a tackle box. The cooler of the present invention may have a plurality of sidewalls and a hinged lid with a cavity in between. The tackle box may include a compartment with a plurality of slots containing a plurality of drawers to store tackle. The present invention may further include a fishing pole rack, a plurality of hooks and additional compartments. The present invention may further include a handle and wheels.

The present invention may include a multi-purpose container 10. The container 10 may include a cooler 62 and a tackle box 64. The cooler 62 may include sidewalls that form a cavity 26 within. The cooler 62 may further include a hinged lid 12 that may be opened and closed to access the cavity 26. The tackle box 64 of the present invention may be attached to the cooler 62. The tackle boxy 64 may include at least one drawer 56 that is extendable from the tackle box 64. The present invention may contain both fishing supplies and anything that needs to be climate controlled.

The container 10 of the present invention may include an upper body 24 and a lower body 60. The upper and lower body 24, 60 may include a front face, a rear face, a first side, a second side, a top and a bottom. In certain embodiments, the upper body 24 may include the cooler 62 and the lower body 60 may include the tackle box 64. The hinged lid 12 may form the top of the upper body 24. The hinged lid 12 may connected to the cooler 62 by lid hinges 18 and may be locked closed by a lid latch 20. In such embodiments, the lid 12 may include cup holders 14 and a bucket holder 16 for buckets 58 used during fishing.

In certain embodiments, the tackle box 64 of the present invention may include at least one compartment with a plurality of slots, in which a plurality of drawers 56 may slide in and out. A hinged door 34 may be attached to the tackle box 64 by door hinges 40 and may contain the drawers 56 when closed and provide access to the drawers 56 when opened. In certain embodiments, the hinged door 34 may include a door window 36. A door latch 38 may lock the hinged door 34 closed. The tackle box 46 may further include a side compartment 50. A side door 42 with a side window 44 may be hinged to the tackle box 64 by side hinge 48. The side door 42 may be opened and closed to access the side compartment 50. A side compartment latch 46 may lock the side door 42 shut.

The present invention may further include hooks and racks to secure fishing poles, nets, buckets, or any other accessories used during fishing. In certain embodiments, the present invention may include a pair of holder hooks 28. The hooks 28 may be located on the upper body 24, such as the front face of the upper body 24. The holder hooks 28 may be used to support a chair. The present invention may further include a fishing pole rack 30, 32. The fishing pole rack 30, 32 may include a base 32 mounted to the lower body 60 and a rack 30 mounted to the upper body 24. Therefore a fishing pole may rest in the rack 30 and may be supported by the base 32. The pair of holder hooks 28 and the fishing pole rack 30, 32 may be in an expanded form and a compressed form. The compressed form may include the pair of holder hooks 28 and the fishing pole rack 30, 32 folded in towards the container 10, and the expanded form may include the pair of holder hooks 28 and fishing pole rack 30, 32 folded outwards and in a position to use.

In certain embodiments, the multi-purpose container 10 may be a portable multi-purpose container 10. As illustrated in the Figures, the container 10 may include wheels 52 on the bottom. In certain embodiments, the present invention may contain two wheels 52 on bottom near the rear face. In certain embodiments, the present invention may include support legs 54 on the bottom near the front face. The present invention may further include a handle 22. In certain embodiments, the handle 22 may be a telescoping handle 22. Therefore, a user may use the handle 22 and wheels 52 to easily push and pull the present invention.

It should be understood, of course, that the foregoing relates to exemplary embodiments of the invention and that modifications may be made without departing from the spirit and scope of the invention as set forth in the following claims.

What is claimed is:

1. A multi-purpose container comprising:
a cooler comprising sidewalls forming a cavity within, wherein the cooler comprises a hinged lid that is opened and closed to access the cavity; and
a tackle box attached to the cooler, wherein the tackle box comprises at least one compartment.

2. The multi-purpose container of claim 1, further comprising an upper body and a lower body forming a front face, a rear face, a first side, a second side, a top, and a bottom, wherein the upper body comprises the cooler and the lower body comprises the tackle box.

3. The multi-purpose container of claim 2, wherein the hinged lid forms the top of the upper body.

4. The multi-purpose container of claim 3, wherein the top comprises at least of a drink holder and a bucket holder.

5. The multi-purpose container of claim 2, wherein the compartment of the tackle box comprises a plurality of drawers extendible from the tackle box and accessible by a hinged door.

6. The multi-purpose container of claim 2, wherein the tackle box further comprises a side compartment accessible by a side hinged door.

7. The multi-purpose container of claim 2, further comprising fishing pole rack mounted to at least one of the first side and the second side.

8. The multi-purpose container of claim 7, wherein the fishing pole rack comprises a base mounted to the lower body and a rack portion mounted to the upper body, wherein the base and the rack portion align.

9. The multi-purpose container of claim 8, further comprising a pair of holder hooks attached to the front face of the upper body.

10. The multi-purpose container of claim 9, wherein the pair of holder hooks and the fishing pole rack comprise an expanded form and a compressed form, wherein the compressed form comprises the pair of holder hooks and the fishing pole rack folded in towards the container, and the expanded form comprises the pair of holder hooks and fishing pole rack folded outwards and in a position to use.

11. The multi-purpose container of claim 2, further comprising wheels mounted to the bottom.

12. The multi-purpose container of claim 11, further comprising a telescoping handle mounted rear surface and extending passed the top.
